(19) United States
(12) Patent Application Publication
(10) Pub. No.: US 2025/0050309 A1
(43) Pub. Date: Feb. 13, 2025

(54) PREPARATION METHOD FOR LIVESTOCK MANURE-BASED SUPERABSORBENT POLYMER

(71) Applicant: Nanchang University, Nanchang (CN)

(72) Inventors: Xianchuan Xie, Nanchang (CN); Yuankai Zhou, Nanchang (CN)

(21) Appl. No.: 18/781,888

(22) Filed: Jul. 23, 2024

(30) Foreign Application Priority Data
Aug. 10, 2023 (CN) 202311007439.2

(51) Int. Cl. B01J 20/22; B01J 20/28; B01J 20/30

(52) U.S. Cl. CPC B01J 20/22; B01J 20/2803; B01J 20/3021; B01J 20/3042; B01J 20/3071; B01J 20/3085

(57) ABSTRACT

The present disclosure specifically relates to a preparation method for a livestock manure-based superabsorbent polymer, including the following steps: stirring livestock manure in distilled water for dispersion; preparing a reactive monomer into a solution for later use; polymerizing a cross-linking agent, an initiator and a monomer in a livestock manure slurry to prepare a crude product of a livestock manure-based superabsorbent polymer; and washing, drying and crushing the crude product to prepare the livestock manure-based superabsorbent polymer. The livestock manure-based superabsorbent polymer prepared by the present disclosure is a black or gray granular solid with high water-retaining property and has broad application prospects in the fields of agriculture, environmental protection and ecology.

### CROSS-REFERENCE TO RELATED APPLICATION

This application claims priority of Chinese Patent Application No. 202311007439.2, filed on Aug. 10, 2023, the entire contents of which are incorporated herein by reference.

### TECHNICAL FIELD

The present disclosure belongs to the technical field of polymer materials, and specifically relates to a preparation method for a livestock manure-based superabsorbent polymer.

### BACKGROUND

A superabsorbent polymer is a polymer material with a three-dimensional reticular pore structure, which has high water absorption and water-retaining properties. At present, superabsorbent polymers synthesized using petrochemical raw materials face the problem of increasing costs year by year, and the difficult degradation of synthetic superabsorbent polymers also limits applications thereof. Therefore, the synthesis of degradable superabsorbent polymer from natural and inexpensive raw materials has become a research hotspot in the art.

Livestock manure, the direct excrement by livestock and poultry digestion and metabolism are the most important wastes in livestock and poultry breeding. The direct discharge of excrement without any treatment will aggravate the environmental pollution day by day. At present, the main treatment method of livestock manure is biochemical conversion, such as composting or biogas fermentation. Resource utilization is carried out at the same time of consumption and treatment of livestock manure. However, these treatment methods generally have the shortcomings of long treatment cycle, incomplete treatment and low efficiency.

Natural polymers such as cellulose and lignin in livestock manure are high-quality raw materials for the preparation of superabsorbent polymer. If the raw materials are processed into polymer materials, it can not only solve the environmental problems caused by livestock manure, but also provide a new idea for the preparation of polymer materials, having broad market application prospects.

### SUMMARY

In view of the deficiencies of the prior art, the present disclosure provides a preparation method for a livestock manure-based superabsorbent polymer. The preparation method has the advantages of readily available raw materials, mild reaction conditions, no need for nitrogen and low cost. The obtained livestock manure-based superabsorbent polymer has good water absorption property, high reusability and excellent biodegradability, and has broad application prospects in the fields of agriculture, environmental protection and ecology.

An aspect of the present disclosure provides a preparation method for a livestock manure-based superabsorbent polymer, including the following steps.
(1) Dispersion of livestock manure: livestock manure is dried, crushed and sieved for later use, and the treated livestock manure is stirred in distilled water at 40-70° C. for uniform dispersion to obtain a livestock manure slurry. In this step, the livestock manure is dried to a constant weight at a relatively low temperature, such as 50-60° C., and crushed, generally crushed to a particle size less than 100 mesh, followed by sieving, to ensure that the subsequent dispersion is more uniform and conducive to form a slurry.
(2) Preparation of monomer solution: a reactive monomer is taken and prepared into a monomer solution, followed by placing the monomer solution in an ice-water bath for later use. In this step, the monomer solution is placed in an ice-water bath to effectively prevent self-polymerization.
(3) Polymerization: a temperature of the livestock manure slurry obtained in step (1) is raised to 60-70° C., an initiator is added for pre-initiation under stirring, the monomer solution and a cross-linking agent are slowly added in sequence, stirring is stopped after a colloidal viscous mass appears in a reaction, and the reaction is continued for 2-3 h to obtain a crude product. In this step, the livestock manure slurry is heated to about 70° C., and the initiator is added to perform a pre-initiation reaction for 0.5-1 min, which can effectively improve the subsequent grafting efficiency.
(4) Product impurity removal: the crude product obtained in step (3) is washed with deionized water, the washed crude product is soaked in anhydrous ethanol, and dehydration, impurity removal, drying and crushing are performed on the product to obtain a livestock manure-based superabsorbent polymer. In this step, the crude product obtained can be cut into pieces with scissors, washed with deionized water, and soaked in anhydrous ethanol to effectively improve the impurity removal efficiency, and the obtained resin has high purity, good absorption effect and good reusability. In the present disclosure, the superabsorbent polymer is prepared by using natural polymers such as cellulose and lignin in livestock manure as raw materials. Compared with the preparation of some superabsorbent polymers based on natural polymers, the natural polymers in livestock manure have been subjected to enzymatic hydrolysis in vivo, have more grafting sites and high reaction activity, and do not need modification pretreatment of raw materials, which can not only save cost but also have better grafting efficiency. Using the natural polymers as raw materials to prepare the superabsorbent polymer can not only achieve the goals of reduction and harmlessness of excrement, reducing environmental pollution, but also achieve the purpose of waste utilization, bringing good environmental and economic benefits.

Preferably, in the above technical solution, raw materials used include, in parts by weight: 5-40 parts of livestock manure, 500-1000 parts of distilled water, 60-120 parts of reactive monomer, 1-7 parts of initiator and 0.5-4 parts of cross-linking agent.

Preferably, in the above technical solution, the livestock manure is one or more of cow excrement, pig excrement, sheep excrement, horse excrement and chicken excrement.

Preferably, in the above technical solution, the reactive monomer is one or more of acrylic acid, acrylamide, methyl acrylate, butyl acrylate, methacrylic acid, methyl methacrylate, hydroxyethyl methacrylate, itaconic acid, vinyl alcohol, polyvinyl alcohol, acrylonitrile, vinyl acetate and methacrylamide.

Preferably, in the above technical solution, when the reactive monomer is acrylic acid, the acrylic acid is prepared into a solution having a neutralization degree of 40-90%.

Preferably, in the above technical solution, the initiator is one or a combination of persulfate, boron containing three alkyl groups, cerium salt, hydrogen peroxide and ascorbic acid.

Preferably, in the above technical solution, the cross-linking agent is one or more of N,N′-methylene bisacrylamide, aluminum hydroxide, polyethylene glycol, glycerol, sodium citrate, tetraethylene glycol diacrylate, divinyl sulfone, glutaraldehyde, epichlorohydrin, ethylene glycol dimethacrylate, diethylene glycol dimethacrylate, polyethylene glycol dimethacrylate, borax and poly(ethylene glycol) (n) diglycidyl ether.

Preferably, in the above technical solution, in step (1), a stirring speed of the dispersion is 400-600 rpm and a stirring time is 25-35 min.

Preferably, in the above technical solution, in step (4), the crude product is washed for 3-4 times with the deionized water and soaked in the anhydrous ethanol for 24-36 h.

Another aspect of the present disclosure further provides a livestock manure-based superabsorbent polymer prepared by the above preparation method.

Compared with the prior art, the present disclosure has the following advantageous effects.
1. In the present disclosure, the polymer superabsorbent polymer is prepared by grafting natural macromolecular substances from livestock manure which is taken as a raw material because of large output, low additional value, and easy availability, to improve an additional value of livestock manure, opening up a channel for the utilization of livestock and poultry breeding wastes, reducing environmental pollution, bringing good environmental and economic benefits and promoting the sustainable development of livestock and poultry breeding economy.
2. In the present disclosure, the livestock manure after enzymatic hydrolysis in animals is taken as a raw material, so that the polymer substances in the livestock manure have a lower crystallinity, more cross-linking active sites and an excellent grafting rate. The modification pretreatment step is omitted, and the preparation time and cost are greatly saved.
3. In the present disclosure, the impact on the surrounding environment caused by the treatment methods is avoided, such as directly returning livestock manure to the field and composting. In addition, the livestock manure-based superabsorbent polymer product provided by the present disclosure has excellent water-retaining property and reusability, and has a positive effect on a granular structure and physicochemical properties of soil in agricultural applications.
4. In the present disclosure, the operation of graft polymerization of livestock manure by aqueous solution is simple; and in a polymerization process, a system viscosity is low, the heat transfer is easy and the temperature is controllable, which can avoid local overheating and can be produced on a large scale.

### BRIEF DESCRIPTION OF THE DRAWINGS

FIG. 1 is a process flow chart for preparing of a livestock manure-based superabsorbent polymer.

FIG. 2 is a diagram showing the appearance and morphology before and after water absorption and swelling of the livestock manure-based superabsorbent polymer.

### DETAILED DESCRIPTION

Each of the above technical features of the present disclosure and each of the technical features specifically described below (e.g., examples) can be combined with each other to constitute a new or preferred technical solution. However, the present disclosure is not limited to only these examples, and likewise these examples do not limit the present disclosure in any way.

Experimental methods in the following examples, unless otherwise specified, are conventional methods. Formulations referred to in the following examples are generally commercially available, unless otherwise specified, and can be purchased on the market.

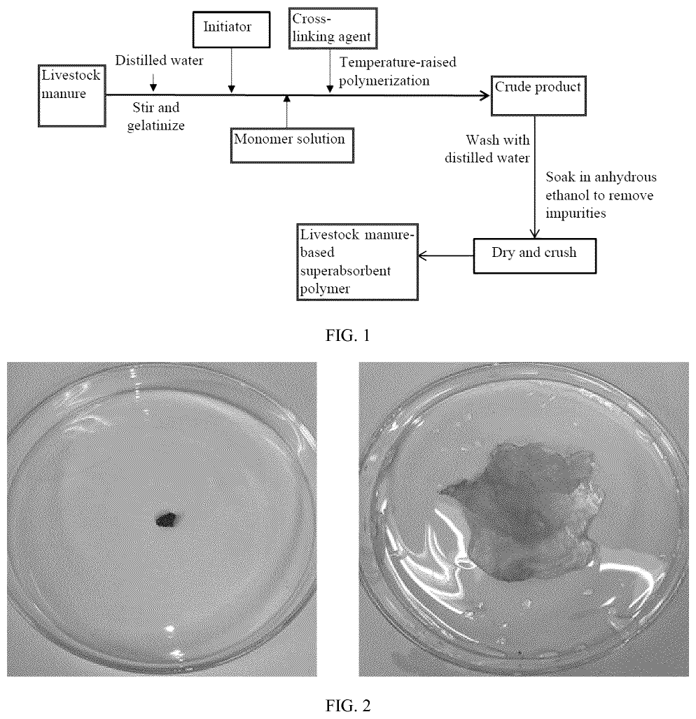

FIG. 1 is a process flow chart for preparing a livestock manure-based superabsorbent polymer according to the present disclosure. The present disclosure will be described in further detail with reference to examples.

### Example 1

A preparation method for a livestock manure-based superabsorbent polymer includes the following specific steps.
(1) Dispersion of livestock manure: cow excrement was dried to a constant weight at 60° C., put into a crusher for crushing, and sieved through a 100-mesh sieve for later use; 10 parts of the cow excrement were weighed and put into a conical flask, 600 parts of distilled water were added, and a mixture was put into a water bath stirring pot and stirred at a temperature of 50° C. and a stirring speed of 400 rpm for 30 min.
(2) Preparation of monomer solution: 80 parts of acrylic acid were taken, 120 parts of distilled water were added, a solution was neutralized with 20% sodium hydroxide solution under an ice-water bath condition, a neutralization degree was adjusted to 70%, and the solution was placed aside for later use.
(3) Polymerization: a temperature of a livestock manure slurry was raised to 70° C., 5 parts of potassium persulfate were added, and a mixture was mixed uniformly with the slurry after reacting for 30 s; and an acrylic acid solution and 2 parts of N,N′-methylene bisacrylamide were added slowly, an original stirring speed was maintained, stirring was stopped when a colloidal viscous substance appeared in the reaction, and the reaction was continued for 3 h to obtain a crude product.
(4) Product impurity removal: the crude product was washed for 3 times with distilled water, soaked in anhydrous ethanol for 12 h and cut into pieces with scissors, followed by continuing the soaking for 12 h to remove non-crosslinked homopolymer and unreacted monomers; and the product was continuously dried at 60° C. for 24 h to a constant weight, and after cooling, the product was crushed and sieved to obtain a cow excrement-based superabsorbent polymer.

### Example 2

A preparation method for a livestock manure-based superabsorbent polymer was provided, which differed from Example 1 in that: 15 parts of cow excrement were used.

### Example 3

A preparation method for a livestock manure-based superabsorbent polymer was provided, which differed from Example 1 in that: 20 parts of cow excrement were used.

### Example 4

A preparation method for a livestock manure-based superabsorbent polymer was provided, which differed from Example 1 in that: 25 parts of cow excrement were used.

### Example 5

A preparation method for a livestock manure-based superabsorbent polymer was provided, which differed from Example 1 in that: 30 parts of cow excrement were used.

### Example 6

A preparation method for a livestock manure-based superabsorbent polymer includes the following specific steps.
(1) Dispersion of livestock manure: pig excrement was dried to a constant weight at 60° C., put into a crusher for crushing, and sieved through a 100-mesh sieve for later use; 10 parts of the pig excrement were weighed and put into a conical flask, 600 parts of distilled water were added, and a mixture was put into a water bath stirring pot, stirred and gelatinized at a temperature of 50° C. and a stirring speed of 500 rpm for 30 min.
(2) Preparation of monomer solution: 100 parts of acrylic acid were taken, 100 parts of distilled water were added, a solution was neutralized with 20% sodium hydroxide solution under an ice-water bath condition, a neutralization degree was adjusted to 70%, and the solution was placed aside for later use.
(3) Polymerization: a temperature of livestock manure liquid was raised to 60° C., 8 parts of potassium persulfate were added, and a mixture was mixed uniformly with the slurry after reacting for 30 s; and an acrylic acid solution and 5 parts of N,N′-methylene bisacrylamide were added slowly, an original stirring speed was maintained, stirring was stopped when a colloidal viscous substance appeared in the reaction, and the reaction was continued for 3 h to obtain a crude product.
(4) Product impurity removal: the crude product was washed for 4 times with distilled water, soaked in anhydrous ethanol for 12 h and cut into pieces with scissors, followed by continuing the soaking for 12 h to remove non-crosslinked homopolymer and unreacted monomers; and the product was continuously dried at 60° C. for 24 h to a constant weight, and after cooling, the product was crushed and sieved to obtain a pig excrement-based superabsorbent polymer.

### Example 7

A preparation method for a livestock manure-based superabsorbent polymer includes the following specific steps.
(1) Dispersion of livestock manure: 5 parts of dried pig excrement and 5 parts of dried cow excrement after 100-mesh sieving were weighed and placed into a conical flask, 500 parts of distilled water were added, and a mixture was placed into a water bath stirring pot, and stirred at a temperature of 50° C. and a stirring speed of 600 rpm for 25 min to obtain a mixed homogeneous slurry.
(2) Preparation of monomer solution: 100 parts of acrylic acid were taken, 200 parts of distilled water were added, a solution was neutralized with 20% sodium hydroxide solution under an ice-water bath condition, a neutralization degree was adjusted to 70%, and the solution was placed aside for later use.
(3) Polymerization: a temperature of a mixed slurry of pig excrement and cow excrement was raised to 80° C., 6 parts of ammonium persulfate were added, and a mixture was mixed uniformly with the slurry after reacting for 30 s; and a monomer solution and 3 parts of N,N′-methylene bisacrylamide were slowly added, an original stirring speed was maintained, stirring was stopped when a colloidal viscous substance appeared in the reaction, and the reaction was continued for 2.5 h to obtain a crude product.
(4) Product impurity removal: the crude product was washed for 3 times with distilled water, soaked in anhydrous ethanol for 12 h and cut into pieces with scissors, followed by continuing the soaking for 12 h to remove non-crosslinked homopolymer and unreacted monomers; and the product was continuously dried at 60° C. for 24 h to a constant weight, and after cooling, the product was crushed and sieved to obtain a superabsorbent polymer.

### Example 8

A preparation method for a livestock manure-based superabsorbent polymer includes the following specific steps.
(1) Dispersion of livestock manure: 5 parts of dried pig excrement and 5 parts of dried cow excrement after 100-mesh sieving were weighed and placed into a conical flask, 50 parts of distilled water were added, and a mixture was placed into a water bath stirring pot, and stirred at a temperature of 50° C. and a stirring speed of 600 rpm for 25 min to obtain a mixed homogeneous slurry.
(2) Preparation of monomer solution: 100 parts of acrylic acid were taken, 200 parts of distilled water were added, a solution was neutralized with 20% sodium hydroxide solution under an ice-water bath condition, and a neutralization degree was adjusted to 70%. In addition, 10 parts of polyvinyl alcohol were dissolved in 100 parts of boiling water, and placed aside for later use after being cooled and blended with an acrylic acid solution.
(3) Polymerization: a temperature of a mixed slurry of pig excrement and cow excrement was raised to 80° C., 6 parts of ammonium persulfate were added, and a mixture was mixed uniformly with the slurry after reacting for 30 s; and a monomer solution and 3 parts of N,N′-methylene bisacrylamide were slowly added, an original stirring speed was maintained, stirring was stopped when a colloidal viscous substance appeared in the reaction, and the reaction was continued for 2.5 h to obtain a crude product.
(4) Product impurity removal: the crude product was washed for 3 times with distilled water, soaked in anhydrous ethanol for 12 h and cut into pieces with scissors, followed by continuing the soaking for 12 h to remove non-crosslinked homopolymer and unreacted monomers; and the product was continuously dried at 60° C. for 24 h to a constant weight, and after cooling, the product was crushed and sieved to obtain a superabsorbent polymer.

### Example 9

A preparation method for a livestock manure-based superabsorbent polymer was provided, which differed from Example 8 in that: 5 parts of glycerol and 2.5 parts N,N′-methylene bisacrylamide were taken as the cross-linking agent.

### Example 10

A preparation method for a livestock manure-based superabsorbent polymer was provided, which differed from Example 1 in that: 10 parts of 3% hydrogen peroxide and 2 parts of ascorbic acid were taken as the initiator.

### Example 11

A preparation method for a livestock manure-based superabsorbent polymer was provided, which differed from Example 1 in that: a blended solution of 90 parts of butyl acrylate and 110 parts of distilled water was taken as the monomer solution.

### Example 12

A preparation method for a livestock manure-based superabsorbent polymer was provided, which differed from Example 1 in that: 8 parts of ethylene glycol dimethacrylate were taken as the cross-linking agent.

The superabsorbent polymers prepared in Examples 1-11 are examined for appearance and water absorption ratio, and results are shown in Table 1. A test method for water-retaining property is as follows: a superabsorbent polymer is placed in an environment at 60° C. after absorbing water to detect a water retention time. A test method for water absorption ratio is as follows: after being weighed, a superabsorbent polymer is placed into deionized water to absorb water and swell for re-weighing to calculate a water absorption ratio. The resin is dried after use, the water absorption and swelling are repeated for several times, and a calculation result is obtained. The appearance and morphology before and after water absorption and swelling of the cow excrement-based superabsorbent polymer obtained in Example 4 are shown in FIG. 2.

TABLE 1

| | | Water- | Primary | Secondary | Tertiary |
|---|---|---|---|---|---|
| | | retaining | water | water | water |
| | | property, | absorption | absorption | absorption |
| Sample | Color | 60° C. | ratio g/g | ratio g/g | ratio g/g |
| Example 1 | Black | 29 h | 349 | 320 | 286 |
| Example 2 | Black | 31 h | 392 | 365 | 338 |
| Example 3 | Black | 32 h | 412 | 393 | 366 |
| Example 4 | Black | 39 h | 494 | 485 | 386 |
| Example 5 | Black | 35 h | 457 | 428 | 348 |
| Example 6 | Grey | 20 h | 194 | 182 | 157 |
| Example 7 | Grey | 23 h | 275 | 263 | 221 |
| Example 8 | Grey | 24 h | 289 | 277 | 235 |
| Example 9 | Grey | 26 h | 314 | 276 | 257 |
| Example 10 | Black | 26 h | 282 | 263 | 214 |
| Example 11 | Black | 26 h | 314 | 287 | 256 |
| Example 12 | Black | 24 h | 256 | 213 | 184 |

As can be seen from the results in Table 1, the livestock manure-based superabsorbent polymer prepared by the method of the present disclosure has a high water absorption speed, good water-retaining property, high water absorption ratio, and excellent reuse property.

Finally, it is to be emphasized that the above is only the preferred example of the present disclosure, which is not used to limit the present disclosure. For those skilled in the art, the present disclosure can be subjected to various changes and modifications, and any modifications, equivalent substitutions, improvements, etc., made within the spirit and principle of the present disclosure are to be included in the scope of protection of the present disclosure.

1. A preparation method for a livestock manure-based superabsorbent polymer, comprising the steps of:
(1) dispersion of livestock manure: drying, crushing and sieving livestock manure for later use, and stirring the treated livestock manure in distilled water at 40-70° C. for uniform dispersion to obtain a livestock manure slurry;
(2) preparation of monomer solution: taking a reactive monomer, and preparing the same into a monomer solution, followed by placing the monomer solution in an ice-water bath for later use;
(3) polymerization: raising a temperature of the livestock manure slurry obtained in step (1) to 60-70° C., adding an initiator for pre-initiation under stirring, slowly adding the monomer solution and a cross-linking agent in sequence, stopping stirring after a colloidal viscous mass appears in a reaction, and continuing the reaction for 2-3 h to obtain a crude product; and
(4) product impurity removal: washing the crude product obtained in step (3) with deionized water, soaking the washed crude product in anhydrous ethanol, and performing dehydration, impurity removal, drying and crushing on the product to obtain a livestock manure-based superabsorbent polymer.

2. The preparation method for a livestock manure-based superabsorbent polymer according to claim 1, wherein raw materials used comprise, in parts by weight: 5-40 parts of livestock manure, 500-1000 parts of distilled water, 60-120 parts of reactive monomer, 1-7 parts of initiator and 0.5-4 parts of cross-linking agent.

3. The preparation method for a livestock manure-based superabsorbent polymer according to claim 1, wherein the livestock manure is one or more of cow excrement, pig excrement, sheep excrement, horse excrement and chicken excrement.

4. The preparation method for a livestock manure-based superabsorbent polymer according to claim 1, wherein the reactive monomer is one or more of acrylic acid, acrylamide, methyl acrylate, butyl acrylate, methacrylic acid, methyl methacrylate, hydroxyethyl methacrylate, itaconic acid, vinyl alcohol, polyvinyl alcohol, acrylonitrile, vinyl acetate and methacrylamide.

5. The preparation method for a livestock manure-based superabsorbent polymer according to claim 2, wherein the reactive monomer is one or more of acrylic acid, acrylamide, methyl acrylate, butyl acrylate, methacrylic acid, methyl methacrylate, hydroxyethyl methacrylate, itaconic acid, vinyl alcohol, polyvinyl alcohol, acrylonitrile, vinyl acetate and methacrylamide.

6. The preparation method for a livestock manure-based superabsorbent polymer according to claim 4, wherein when the reactive monomer is acrylic acid, the acrylic acid is prepared into a solution having a neutralization degree of 40-90%.

7. The preparation method for a livestock manure-based superabsorbent polymer according to claim 1, wherein the initiator is one or a combination of persulfate, boron containing three alkyl groups, cerium salt, hydrogen peroxide and ascorbic acid.

8. The preparation method for a livestock manure-based superabsorbent polymer according to claim 2, wherein the initiator is one or a combination of persulfate, boron containing three alkyl groups, cerium salt, hydrogen peroxide and ascorbic acid.

9. The preparation method for a livestock manure-based superabsorbent polymer according to claim 1, wherein the cross-linking agent is one or more of N,N′-methylene bisacrylamide, aluminum hydroxide, polyethylene glycol, glycerol, sodium citrate, tetraethylene glycol diacrylate, divinyl sulfone, glutaraldehyde, epichlorohydrin, ethylene glycol dimethacrylate, diethylene glycol dimethacrylate, polyethylene glycol dimethacrylate, borax and poly(ethylene glycol) (n) diglycidyl ether.

10. The preparation method for a livestock manure-based superabsorbent polymer according to claim 2, wherein the cross-linking agent is one or more of N,N′-methylene bisacrylamide, aluminum hydroxide, polyethylene glycol, glycerol, sodium citrate, tetraethylene glycol diacrylate, divinyl sulfone, glutaraldehyde, epichlorohydrin, ethylene glycol dimethacrylate, diethylene glycol dimethacrylate, polyethylene glycol dimethacrylate, borax and poly(ethylene glycol) (n) diglycidyl ether.

11. The preparation method for a livestock manure-based superabsorbent polymer according to claim 1, wherein in step (1), a stirring speed of the dispersion is 400-600 rpm and a stirring time is 25-35 min.

12. The preparation method for a livestock manure-based superabsorbent polymer according to claim 1, wherein in step (4), the crude product is washed for 3-4 times with the deionized water and soaked in the anhydrous ethanol for 24-36 h.

13. A livestock manure-based superabsorbent polymer prepared by a preparation method according to claim 1.

14. A livestock manure-based superabsorbent polymer prepared by a preparation method according to claim 2.

15. A livestock manure-based superabsorbent polymer prepared by a preparation method according to claim 3.

16. A livestock manure-based superabsorbent polymer prepared by a preparation method according to claim 4.

17. A livestock manure-based superabsorbent polymer prepared by a preparation method according to claim 5.

18. A livestock manure-based superabsorbent polymer prepared by a preparation method according to claim 6.

19. A livestock manure-based superabsorbent polymer prepared by a preparation method according to claim 7.

20. A livestock manure-based superabsorbent polymer prepared by a preparation method according to claim 8.
